(19) United States
(12) Patent Application Publication
(10) Pub. No.: US 2021/0389906 A1
(43) Pub. Date: Dec. 16, 2021

(54) System and Method for Smart User Polling

(71) Applicant: EMC IP Holding Company, LLC, Hopkinton, MA (US)

(72) Inventors: ELDAD ZINGER, Raanana (IL); Leonid Ravich, Yatzitz (IL)

(21) Appl. No.: 16/898,657

(22) Filed: Jun. 11, 2020

(51) Int. Cl. G06F 3/06; G06F 15/173

(52) U.S. Cl. CPC G06F 3/0659; G06F 15/17331; G06F 3/0673; G06F 3/0611

(57) ABSTRACT

A method, computer program product, and computer system for receiving, by a computing device, a command, wherein the command may include one of a write command and a read command. A completion request for a first portion of the command may be placed in a first queue when the completion request is a first type of completion request. An interrupt operation for the completion request may be executed when the completion request is the first type of completion request. The completion request for a second portion of the command may be placed in a second queue when the completion request is a second type of completion request. A polling operation for the completion request may be executed when the completion request is the second type of completion request.

### BACKGROUND

In some storage solutions, the I/O command flow may begin when the front-end hardware receives a command from the host. The I/O command flow may end when the front-end hardware sends a command completion to the host. The interaction between the storage system software and the front-end hardware may be performance critical.

### BRIEF SUMMARY OF DISCLOSURE

In one example implementation, a method, performed by one or more computing devices, may include but is not limited to receiving, by a computing device, a command, wherein the command may include one of a write command and a read command. A completion request for a first portion of the command may be placed in a first queue when the completion request is a first type of completion request. An interrupt operation for the completion request may be executed when the completion request is the first type of completion request. The completion request for a second portion of the command may be placed in a second queue when the completion request is a second type of completion request. A polling operation for the completion request may be executed when the completion request is the second type of completion request.

One or more of the following example features may be included. The first type of completion request may be a completion of a receive request for the command. The second type of completion request may be a completion of a read request for the command. The second type of completion request may be a completion of a send request for the command. The first queue may be a remote direct memory access completion queue for the interrupt operation. The second queue may be a remote direct memory access completion queue for the polling operation. The first queue may be a send queue, and the second queue may be a receive queue.

In another example implementation, a computing system may include one or more processors and one or more memories configured to perform operations that may include but are not limited to receiving a command, wherein the command may include one of a write command and a read command. A completion request for a first portion of the command may be placed in a first queue when the completion request is a first type of completion request. An interrupt operation for the completion request may be executed when the completion request is the first type of completion request. The completion request for a second portion of the command may be placed in a second queue when the completion request is a second type of completion request. A polling operation for the completion request may be executed when the completion request is the second type of completion request.

One or more of the following example features may be included. The first type of completion request may be a completion of a receive request for the command. The second type of completion request may be a completion of a read request for the command. The second type of completion request may be a completion of a send request for the command. The first queue may be a remote direct memory access completion queue for the interrupt operation. The second queue may be a remote direct memory access completion queue for the polling operation. The first queue may be a send queue, and the second queue may be a receive queue.

In another example implementation, a computer program product may reside on a computer readable storage medium having a plurality of instructions stored thereon which, when executed across one or more processors, may cause at least a portion of the one or more processors to perform operations that may include but are not limited to receiving a command, wherein the command may include one of a write command and a read command. A completion request for a first portion of the command may be placed in a first queue when the completion request is a first type of completion request. An interrupt operation for the completion request may be executed when the completion request is the first type of completion request. The completion request for a second portion of the command may be placed in a second queue when the completion request is a second type of completion request. A polling operation for the completion request may be executed when the completion request is the second type of completion request.

One or more of the following example features may be included. The first type of completion request may be a completion of a receive request for the command. The second type of completion request may be a completion of a read request for the command. The second type of completion request may be a completion of a send request for the command. The first queue may be a remote direct memory access completion queue for the interrupt operation. The second queue may be a remote direct memory access completion queue for the polling operation. The first queue may be a send queue, and the second queue may be a receive queue.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a I/O process coupled to an example distributed computing network according to one or more example implementations of the disclosure;

FIG. 2 is an example diagrammatic view of a storage system of FIG. 1 according to one or more example implementations of the disclosure;

FIG. 3 is an example diagrammatic view of a storage target of FIG. 1 according to one or more example implementations of the disclosure; and

FIG. 4 is an example flowchart of a I/O process according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

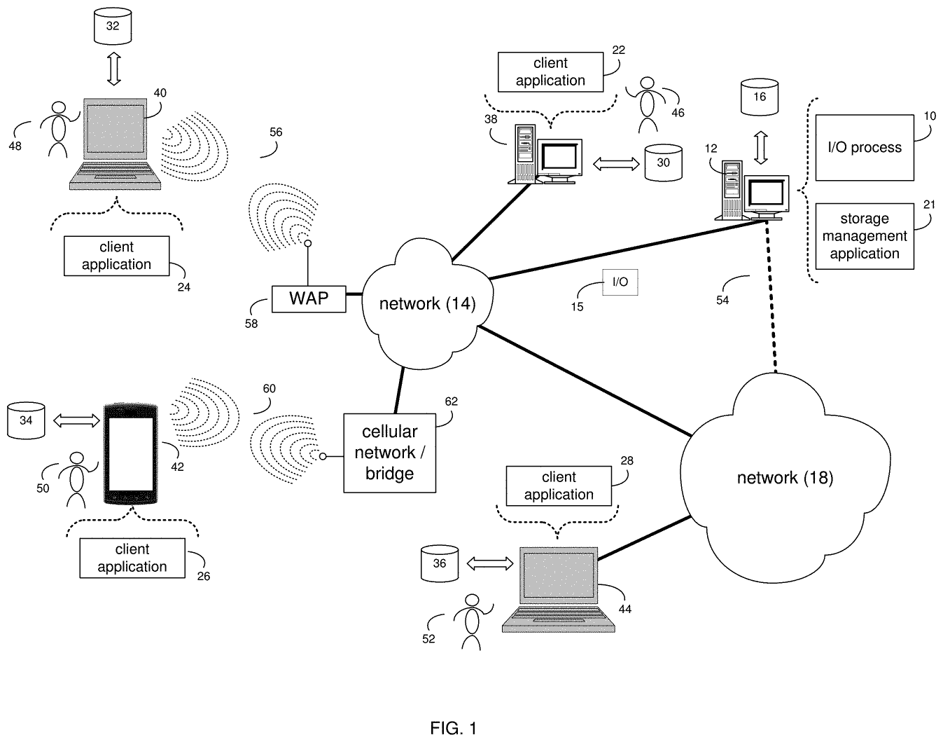

Referring now to the example implementation of FIG. 1, there is shown I/O process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a I/O process, such as I/O process 10 of FIG. 1, may receive, by a computing device, a command, wherein the command may include one of a write command and a read command. A completion request for a first portion of the command may be placed in a first queue when the completion request is a first type of completion request. An interrupt operation for the completion request may be executed when the completion request is the first type of completion request. The completion request for a second portion of the command may be placed in a second queue when the completion request is a second type of completion request. A polling operation for the completion request may be executed when the completion request is the second type of completion request.

In some implementations, the instruction sets and subroutines of I/O process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, I/O process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a storage management application (e.g., storage management application 21), examples of which may include, but are not limited to, e.g., a storage system application, a cloud computing application, a data synchronization application, a data migration application, a garbage collection application, or other application that allows for the implementation and/or management of data in a clustered (or non-clustered) environment (or the like). In some implementations, I/O process 10 and/or storage management application 21 may be accessed via one or more of client applications 22, 24, 26, 28. In some implementations, I/O process 10 may be a standalone application, or may be an applet/application/script/extension that may interact with and/or be executed within storage management application 21, a component of storage management application 21, and/or one or more of client applications 22, 24, 26, 28. In some implementations, storage management application 21 may be a standalone application, or may be an applet/application/script/extension that may interact with and/or be executed within I/O process 10, a component of I/O process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of I/O process 10 and/or storage management application 21. Examples of client applications 22, 24, 26, 28 may include, but are not limited to, e.g., a storage system application, a cloud computing application, a data synchronization application, a data migration application, a garbage collection application, or other application that allows for the implementation and/or management of data in a clustered (or non-clustered) environment (or the like), a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of I/O process 10 (and vice versa). Accordingly, in some implementations, I/O process 10 may be a purely server-side application, a purely client-side application, or a hybrid server-side/client-side application that is cooperatively executed by one or more of client applications 22, 24, 26, 28 and/or I/O process 10.

In some implementations, one or more of client applications 22, 24, 26, 28 may be configured to effectuate some or all of the functionality of storage management application 21 (and vice versa). Accordingly, in some implementations, storage management application 21 may be a purely server-side application, a purely client-side application, or a hybrid server-side/client-side application that is cooperatively executed by one or more of client applications 22, 24, 26, 28 and/or storage management application 21. As one or more of client applications 22, 24, 26, 28, I/O process 10, and storage management application 21, taken singly or in any combination, may effectuate some or all of the same functionality, any description of effectuating such functionality via one or more of client applications 22, 24, 26, 28, I/O process 10, storage management application 21, or combination thereof, and any described interaction(s) between one or more of client applications 22, 24, 26, 28, I/O process 10, storage management application 21, or combination thereof to effectuate such functionality, should be taken as an example only and not to limit the scope of the disclosure.

In some implementations, one or more of users 46, 48, 50, 52 may access computer 12 and I/O process 10 (e.g., using one or more of client electronic devices 38, 40, 42, 44) directly through network 14 or through secondary network 18. Further, computer 12 may be connected to network 14 through secondary network 18, as illustrated with phantom link line 54. I/O process 10 may include one or more user interfaces, such as browsers and textual or graphical user interfaces, through which users 46, 48, 50, 52 may access I/O process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12. Examples of I/O request 15 may include but are not limited to, data write requests (e.g., a request that content be written to computer 12) and data read requests (e.g., a request that content be read from computer 12).

Data Storage System:

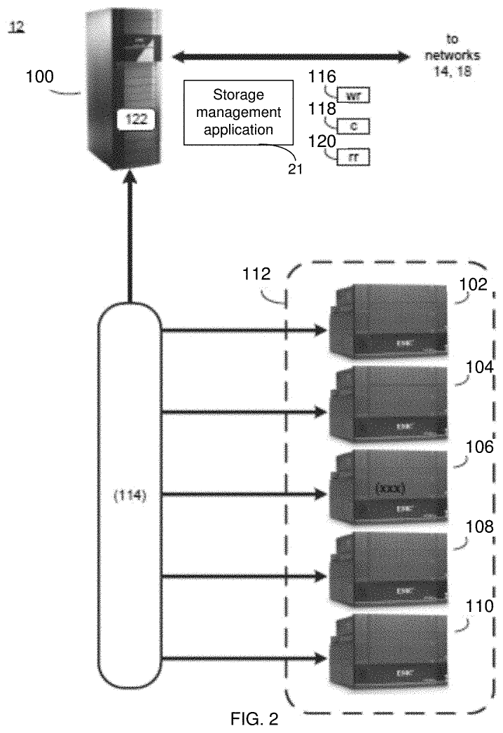

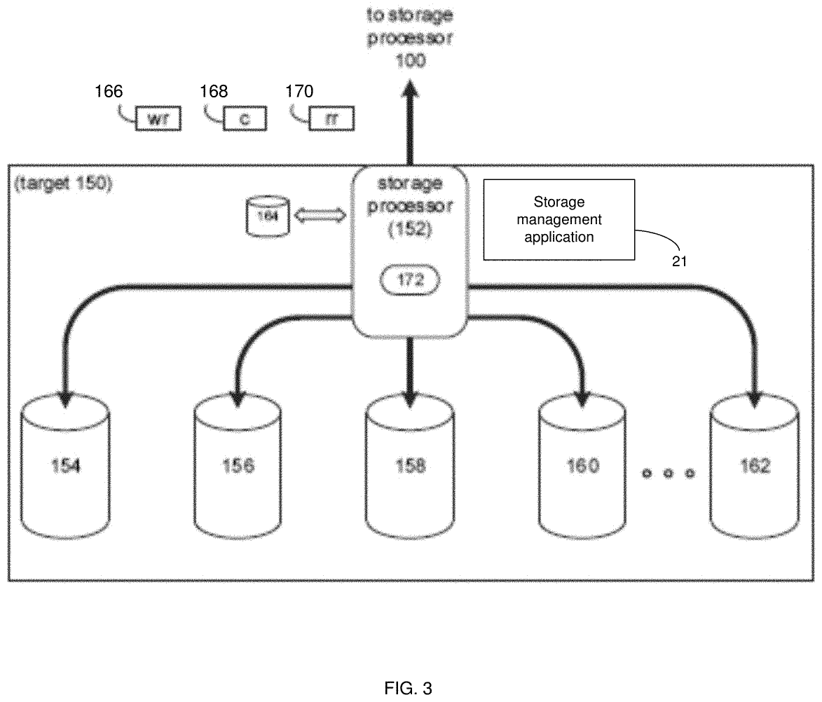

Referring also to the example implementation of FIGS. 2-3 (e.g., where computer 12 may be configured as a data storage system), computer 12 may include storage processor 100 and a plurality of storage targets (e.g., storage targets 102, 104, 106, 108, 110). In some implementations, storage targets 102, 104, 106, 108, 110 may include any of the above-noted storage devices. In some implementations, storage targets 102, 104, 106, 108, 110 may be configured to provide various levels of performance and/or high availability. For example, storage targets 102, 104, 106, 108, 110 may be configured to form a non-fully-duplicative fault-tolerant data storage system (such as a non-fully-duplicative RAID data storage system), examples of which may include but are not limited to: RAID 3 arrays, RAID 4 arrays, RAID 5 arrays, and/or RAID 6 arrays. It will be appreciated that various other types of RAID arrays may be used without departing from the scope of the present disclosure.

While in this particular example, computer 12 is shown to include five storage targets (e.g., storage targets 102, 104, 106, 108, 110), this is for example purposes only and is not intended limit the present disclosure. For instance, the actual number of storage targets may be increased or decreased depending upon, e.g., the level of redundancy/performance/capacity required.

Further, the storage targets (e.g., storage targets 102, 104, 106, 108, 110) included with computer 12 may be configured to form a plurality of discrete storage arrays. For instance, and assuming for example purposes only that computer 12 includes, e.g., ten discrete storage targets, a first five targets (of the ten storage targets) may be configured to form a first RAID array and a second five targets (of the ten storage targets) may be configured to form a second RAID array.

In some implementations, one or more of storage targets 102, 104, 106, 108, 110 may be configured to store coded data (e.g., via storage management process 21), wherein such coded data may allow for the regeneration of data lost/corrupted on one or more of storage targets 102, 104, 106, 108, 110. Examples of such coded data may include but is not limited to parity data and Reed-Solomon data. Such coded data may be distributed across all of storage targets 102, 104, 106, 108, 110 or may be stored within a specific storage target.

Examples of storage targets 102, 104, 106, 108, 110 may include one or more data arrays, wherein a combination of storage targets 102, 104, 106, 108, 110 (and any processing/control systems associated with storage management application 21) may form data array 112.

The manner in which computer 12 is implemented may vary depending upon e.g., the level of redundancy/performance/capacity required. For example, computer 12 may be configured as a SAN (i.e., a Storage Area Network), in which storage processor 100 may be, e.g., a dedicated computing system and each of storage targets 102, 104, 106, 108, 110 may be a RAID device. An example of storage processor 100 may include but is not limited to a VPLEX™, VNX™, TRIDENT™, or Unity™ system offered by Dell EMC™ of Hopkinton, Mass.

In the example where computer 12 is configured as a SAN, the various components of computer 12 (e.g., storage processor 100, and storage targets 102, 104, 106, 108, 110) may be coupled using network infrastructure 114, examples of which may include but are not limited to an Ethernet (e.g., Layer 2 or Layer 3) network, a fiber channel network, an InfiniB and network, or any other circuit switched/packet switched network.

As discussed above, various I/O requests (e.g., I/O request 15) may be generated. For example, these I/O requests may be sent from, e.g., client applications 22, 24, 26, 28 to, e.g., computer 12. Additionally/alternatively (e.g., when storage processor 100 is configured as an application server or otherwise), these I/O requests may be internally generated within storage processor 100 (e.g., via storage management process 21). Examples of I/O request 15 may include but are not limited to data write request 116 (e.g., a request that content 118 be written to computer 12) and data read request 120 (e.g., a request that content 118 be read from computer 12).

In some implementations, during operation of storage processor 100, content 118 to be written to computer 12 may be received and/or processed by storage processor 100 (e.g., via storage management process 21). Additionally/alternatively (e.g., when storage processor 100 is configured as an application server or otherwise), content 118 to be written to computer 12 may be internally generated by storage processor 100 (e.g., via storage management process 21).

As discussed above, the instruction sets and subroutines of storage management application 21, which may be stored on storage device 16 included within computer 12, may be executed by one or more processors and one or more memory architectures included with computer 12. Accordingly, in addition to being executed on storage processor 100, some or all of the instruction sets and subroutines of storage management application 21 (and/or I/O process 10) may be executed by one or more processors and one or more memory architectures included with data array 112.

In some implementations, storage processor 100 may include front end cache memory system 122. Examples of front end cache memory system 122 may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

In some implementations, storage processor 100 may initially store content 118 within front end cache memory system 122. Depending upon the manner in which front end cache memory system 122 is configured, storage processor 100 (e.g., via storage management process 21) may immediately write content 118 to data array 112 (e.g., if front end cache memory system 122 is configured as a write-through cache) or may subsequently write content 118 to data array 112 (e.g., if front end cache memory system 122 is configured as a write-back cache).

In some implementations, one or more of storage targets 102, 104, 106, 108, 110 may include a backend cache memory system. Examples of the backend cache memory system may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

Storage Targets:

As discussed above, one or more of storage targets 102, 104, 106, 108, 110 may be a RAID device. For instance, and referring also to FIG. 3, there is shown example target 150, wherein target 150 may be one example implementation of a RAID implementation of, e.g., storage target 102, storage target 104, storage target 106, storage target 108, and/or storage target 110. An example of target 150 may include but is not limited to a VPLEX™, VNX™, TRIDENT™, or Unity™ system offered by Dell EMC™ of Hopkinton, Mass. Examples of storage devices 154, 156, 158, 160, 162 may include one or more electro-mechanical hard disk drives, one or more solid-state/flash devices, and/or any of the above-noted storage devices. It will be appreciated that while the term “disk” or “drive” may be used throughout, these may refer to and be used interchangeably with any types of appropriate storage devices as the context and functionality of the storage device permits.

In some implementations, target 150 may include storage processor 152 and a plurality of storage devices (e.g., storage devices 154, 156, 158, 160, 162). Storage devices 154, 156, 158, 160, 162 may be configured to provide various levels of performance and/or high availability (e.g., via storage management process 21). For example, one or more of storage devices 154, 156, 158, 160, 162 (or any of the above-noted storage devices) may be configured as a RAID 0 array, in which data is striped across storage devices. By striping data across a plurality of storage devices, improved performance may be realized. However, RAID 0 arrays may not provide a level of high availability. Accordingly, one or more of storage devices 154, 156, 158, 160, 162 (or any of the above-noted storage devices) may be configured as a RAID 1 array, in which data is mirrored between storage devices. By mirroring data between storage devices, a level of high availability may be achieved as multiple copies of the data may be stored within storage devices 154, 156, 158, 160, 162.

While storage devices 154, 156, 158, 160, 162 are discussed above as being configured in a RAID 0 or RAID 1 array, this is for example purposes only and not intended to limit the present disclosure, as other configurations are possible. For example, storage devices 154, 156, 158, 160, 162 may be configured as a RAID 3, RAID 4, RAID 5 or RAID 6 array.

While in this particular example, target 150 is shown to include five storage devices (e.g., storage devices 154, 156, 158, 160, 162), this is for example purposes only and not intended to limit the present disclosure. For instance, the actual number of storage devices may be increased or decreased depending upon, e.g., the level of redundancy/performance/capacity required.

In some implementations, one or more of storage devices 154, 156, 158, 160, 162 may be configured to store (e.g., via storage management process 21) coded data, wherein such coded data may allow for the regeneration of data lost/corrupted on one or more of storage devices 154, 156, 158, 160, 162. Examples of such coded data may include but are not limited to parity data and Reed-Solomon data. Such coded data may be distributed across all of storage devices 154, 156, 158, 160, 162 or may be stored within a specific storage device.

The manner in which target 150 is implemented may vary depending upon e.g., the level of redundancy/performance/capacity required. For example, target 150 may be a RAID device in which storage processor 152 is a RAID controller card and storage devices 154, 156, 158, 160, 162 are individual “hot-swappable” hard disk drives. Another example of target 150 may be a RAID system, examples of which may include but are not limited to an NAS (i.e., Network Attached Storage) device or a SAN (i.e., Storage Area Network).

In some implementations, storage target 150 may execute all or a portion of storage management application 21. The instruction sets and subroutines of storage management application 21, which may be stored on a storage device (e.g., storage device 164) coupled to storage processor 152, may be executed by one or more processors and one or more memory architectures included with storage processor 152. Storage device 164 may include but is not limited to any of the above-noted storage devices.

As discussed above, computer 12 may be configured as a SAN, wherein storage processor 100 may be a dedicated computing system and each of storage targets 102, 104, 106, 108, 110 may be a RAID device. Accordingly, when storage processor 100 processes data requests 116, 120, storage processor 100 (e.g., via storage management process 21) may provide the appropriate requests/content (e.g., write request 166, content 168 and read request 170) to, e.g., storage target 150 (which is representative of storage targets 102, 104, 106, 108 and/or 110).

In some implementations, during operation of storage processor 152, content 168 to be written to target 150 may be processed by storage processor 152 (e.g., via storage management process 21). Storage processor 152 may include cache memory system 172. Examples of cache memory system 172 may include but are not limited to a volatile, solid-state, cache memory system (e.g., a dynamic RAM cache memory system) and/or a non-volatile, solid-state, cache memory system (e.g., a flash-based, cache memory system). During operation of storage processor 152, content 168 to be written to target 150 may be received by storage processor 152 (e.g., via storage management process 21) and initially stored (e.g., via storage management process 21) within front end cache memory system 172.

In some storage solutions, the I/O command flow may begin when the front-end hardware receives a command from the host. The I/O command flow may end when the front-end hardware sends a command completion to the host. The interaction between the storage system software and the front-end hardware may be performance critical. The challenge may be, for example, to find a way for the software to know when the read the completion queue (CQ) for new entries. This may be a challenge, for example, because if the system reads the CQ and there are no new completions to process, then the system has wasted CPU time. On the other hand, the system may benefit from processing a remoted direct memory access (RDMA) completion as soon as possible, because it may affect the total storage system performance. There may be two common solutions for this example problem. (1) Use interrupts: this may reduce the command latency, and does not read the CQ for nothing. This may be bad for CPU efficiency as the context switches may be expensive. (2) Use periodic polling threads: this may be more efficient in the CPU, but may be bad for latency.

The current Linux kernel (or similar) implementation may be based on interrupts that trigger kernel work requests:

For example, the non-volatile memory express (NVME) over fabric (NVMEoF) RDMA write command flow may currently include as the existing flow:

1. Target host bus adapter (HBA) writes of the NVMEoF command capsule to a buffer (that was pre-registered when the target NVMEoF driver submitted a receive request) and fills a work request (receive request) completion in the RDMA CQ.

2. Target HBA raises an interrupt.

3. Target NVMEoF driver interrupt handler queues a kernel work request on RDMA work queue.

4. Some kernel worker thread wakes up and processes the work structure. It parses the NVMEoF command capsule and submits an RDMA work request to the RDMA queue pair (QP). This work request is a read request.

5. Target HBA reads data from the host memory through the host HBA and fills a work request (read request) completion in the RDMA CQ.

6. Target HBA raises an interrupt.

7. Target NVMEoF driver interrupt handler queues a kernel work request on the RDMA work queue.

8. Some kernel worker thread wakes up and processes the work structure. It pushes this command capsule (and data) to a queue to be handled by an upper layer (e.g., block layer or storage system's data path).

9. Upper layer should call the NVMEoF target driver when the storage processing has completed. This flow submits an RDMA work request to the RDMA QP. This work request is a send request.

10. Target HBA sends the RDMA command (holds the NVMEoF command completion) to the host HBA and fills a work request (send request) completion in the RDMA CQ.

11. Target HBA raises an interrupt.

12. Target NVMEoF driver interrupt handler queues a kernel work request on RDMA work queue.

13. Some kernel worker thread wakes up and processes the work structure. It frees all the resources that are associated with the completed NVMEoF command.

Notice that this flow is for NVMEoF write commands that are not inline.

Similarly, NVMEoF RDMA read command flow may currently include as the existing flow:

1. Target HBA writes the NVMEoF command capsule to a buffer (that was pre-registered when the target NVMEoF driver submitted a receive request) and fills a work request (receive request) completion in the RDMA CQ.

2. Target HBA raises an interrupt.

3. Target NVMEoF driver interrupt handler queues a kernel work request on RDMA work queue.

4. Some kernel worker thread wakes up and processes the work structure. It pushes this command capsule to a queue to be handled by upper layer (e.g., block layer or the storage system's data path).

5. Upper layer should call the NVMEoF target driver when the storage processing has completed. This flow submits a list of two RDMA work requests to the RDMA QP. This work request is a write request (the data) that is followed by a send request (e.g., the NVMEoF command completion).

6. Target HBA sends the RDMA command (holds the NVMEoF command completion) to the host HBA and fills a work request (send request) completion in the RDMA CQ.

7. Target HBA raises an interrupt.

8. Target NVMEoF driver interrupt handler queues a kernel work request on the RDMA work queue.

9. Some kernel worker thread wakes up and processes the work structure. It frees all the resources that are associated with the completed NVMEoF command.

An example and non-limiting problem with the above is the extensive use of interrupts and work queues. For example, each interrupt may force a context switch, which may be when the running user space process is inside a critical section. The interrupt is likely to cause a cache miss, which may waste expensive CPU cycles. The interrupt may need to be managed. Its affinity may need to be set according to the system configuration. The interrupt may have an inherent CPU time overhead, which may be beneficial to reduce. The same goes for the RDMA kernel worker thread: context switches, cache misses, CPU affinity configuration problems, overhead, etc.

Generally, to solve these example problems, the approach is to process in batches, to spread inherent polling overhead to several commands. As well, remove the interrupts and use periodic polling logic. Instead of the kernel worker threads, integrate the polling logic into the running framework and poll from inside the framework (user space). This may solve the CPU affinity configuration problem and the uncontrolled context switches. A different approach may be to dedicate CPU cores to the interrupts and kernel workers, but this configuration may not be efficient from the CPU utilization aspect and in some systems, there are no space CPU cores to dedicate. Thus, as can be seen, each of the common approaches (interrupts vs periodic polling) comes with a price. Therefore, as will be discussed below, the present disclosure may include a hybrid approach, that may utilize both interrupts and periodic pollers, each used in the most beneficial place.

As will be discussed below, I/O process 10 may at least help, e.g., improve existing technological processes, necessarily rooted in computer technology in order to overcome an example and non-limiting problem specifically arising in the realm of computer storage systems that may be integrated into the practical application of more efficiently processing I/O command flows. It will be appreciated that the computer processes described throughout are integrated into one or more practical applications, and when taken at least as a whole are not considered to be well-understood, routine, and conventional functions.

The I/O Process:

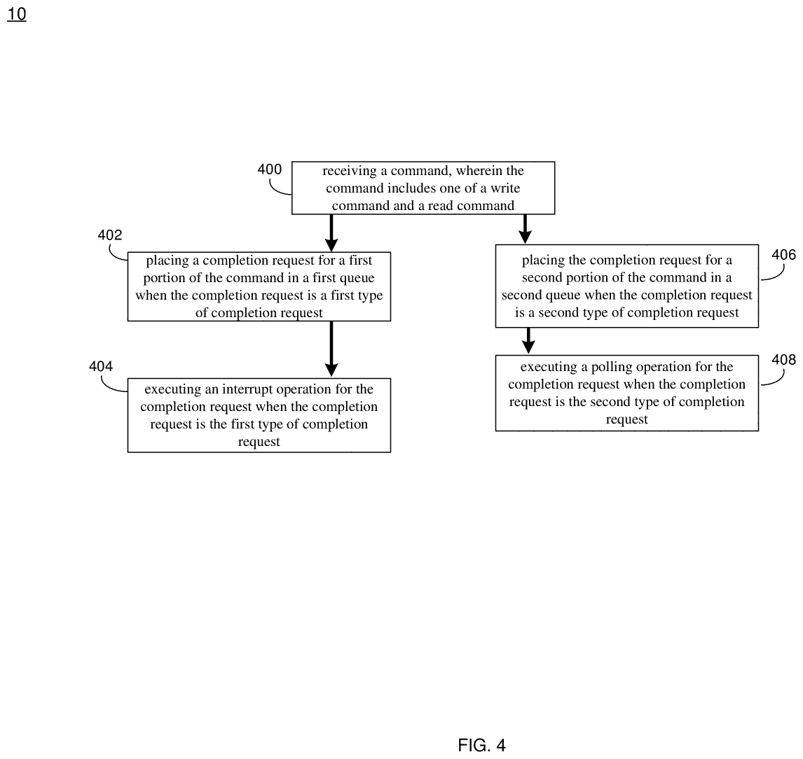

As discussed above and referring also at least to the example implementations of FIG. 4, I/O process 10 may receive 400, by a computing device, a command, wherein the command may include one of a write command and a read command. I/O process 10 may place 402 a completion request for a first portion of the command in a first queue when the completion request is a first type of completion request. I/O process 10 may execute 404 an interrupt operation for the completion request executed when the completion request is the first type of completion request. I/O process 10 may place 406 the completion request for a second portion of the command in a second queue when the completion request is a second type of completion request. I/O process 10 may execute 408 a polling operation for the completion request when the completion request is the second type of completion request.

As will be appreciated, only some interrupts (of the above-noted flows) should be replaced by periodic polling but some should not. Furthermore, the RDMA API may allow a queue topology in which a single QP may be attached to two CQs. Simply replacing the all interrupts with polling from the user space may not achieve the above-noted goals, since there are several types of interrupts, and based upon the type of interrupt, it may be beneficial to be replaced with a periodic polling.

In some implementations, I/O process 10 may receive 400, by a computing device, a command, wherein the command may include one of a write command and a read command. For instance, as noted above, assume for example purposes only that I/O process 10 receives 400 either a write command (e.g., NVME of RDMA write command with the example steps 1-13 in the above-noted write command flow) or a read command (e.g., NVME of RDMA read command with the example steps 1-9 in the above-noted read command flow).

In some implementations, I/O process 10 may place 402 a completion request for a first portion of the command in a first queue when the completion request is a first type of completion request, where in some implementations, the first type of completion request may be a completion of a receive request for the command, and in some implementations, the first queue may be a remote direct memory access (RDMA) completion queue (CQ) for the interrupt operation. For example, one type of interrupt may be that a receive request has completed. This may happen when any new NVMEoF command capsule (or similar) is received by the target. If this is a non-inline write command, then the target may post an RDMA read request as soon as possible, because command processing may start only after the user data has arrived at the target. This may mean that this RDMA completion is latency critical. If this interrupt is replaced with periodic polling, this may hurt the command latency, because an RDMA read request may be submitted only after a polling thread will poll. As such, in the example, when the first portion of the I/O command (e.g., the portion where the target HBA raises a receive request completed interrupt, such as shown in step 2 of both the write and read command flows noted above), is received 400 and determined to be the first type of completion request (e.g., receive request completion), I/O process 10 may place 402 the completion request for that first portion of the command in the first queue (e.g., a particular RDMA CQ (a receive queue)). As a result, in some implementations, I/O process 10 may execute 404 an interrupt operation for the completion request executed when the completion request is the first type of completion request.

In some implementations, I/O process 10 may place 406 the completion request for a second portion of the command in a second queue when the completion request is a second type of completion request, where in some implementations, the second type of completion request may be a completion of a read request for the command, and in some implementations, the second type of completion request may be a completion of a send request for the command, and in some implementations, the second queue may be a remote direct memory access completion queue for the polling operation. For example, another type of interrupt may be that a read request has completed. This may happen when the user data of a non-inline NVMEoF write command has been read from the host by the target. In some storage systems, after this read request has completed, the NVMEoF write command may be enqueued, waiting for a user space poller to dequeue and process it. Since the command may be enqueued anyway after the interrupt, and since the poller latency is already part of the flow, there may be no benefit to use an interrupt here. That is, no point to “hurry up” if the system is just going to enqueue the command, waiting for some software thread to dequeue it. In this case, it makes sense to modify the software thread (e.g., user space poller) to poll the RDMA CQ before dequeuing NVMEoF commands. As such, in the example, when the second portion of the I/O command (e.g., the portion of the command where the target HBA raises a read request completed interrupt, such as shown in step 6 in the write command flow and step 7 in the read command flows noted above), is received 400 and determined to be the second type of completion request (e.g., read request completion), I/O process 10 may place 406 the completion request for that second portion of the command in the second queue (e.g., another particular RDMA CQ (a send queue) that is different from the RDMA CQ noted above for the first portion of the I/O command determined to be the first type of completion request) RDMA CQ). As a result, in some implementations, I/O process 10 may execute 408 a polling operation for the completion request when the completion request is the second type of completion request. In other words, the portion(s) of the command where the target HBA raises a read request completed interrupt, such as shown in step 6 in the write command flow and step 7 in the read command flows noted above, is instead replaced with a polling operation to be executed.

As another example, another type of interrupt may be that a send request has completed. This may happen when the NVMEoF command completion has been sent to the host. For this type of interrupt, if it is replaced with a periodic polling, the only logic that may be delayed (by the polling period) is the logic that clears the command resources. Assuming that there are enough resources, there is no reason to “hurry up” with this task and I/O process 10 may safely poll the RDMA CQ from a periodic poller (e.g., via I/O process 10). As such, in the example, when the second portion of the I/O command (e.g., the portion of the command where the target HBA raises a send request completed interrupt, such as shown in step 11 in the write command flow noted above), is received 400 and determined to be the second type of completion request (e.g., send request completion), I/O process 10 may similarly place 406 the completion request for that portion of the command in the second queue (e.g., the same RDMA CQ send queue where the read request completion was placed). As a result, in some implementations, I/O process 10 may execute 408 a polling operation for the completion request when the completion request is the second type of completion request. In other words, the portion(s) of the command where the target HBA raises a send request completed interrupt, such as shown in step 11 in the write command flow noted above, is instead replaced with a polling operation to be executed.

As such, to disable and replace only two out of three interrupt types with polling, the RDMA QP may be made of two RDMA work queues: Send Queue and Receive Queue. Receive requests are posted by I/O process 10 to the Receive Queue. Send request, as well as Write and Read requests, are posted by I/O process 10 to the Send Queue. Although the RDMA API may bind a CQ to a QP, is it possible to bind a CQ to a work queue. This means that the system may have one CQ that holds all the completions of the Receive Queue, and a second CQ that holds all the completions of the Send Queue. Since RDMA interrupts are configured per CQ, there may be some completions with interrupts and some without interrupts (to be replaced with polling).

Accordingly, by configuring the CQ of the Receive Queue to use interrupts, while configuring the CQ of the Send Queue to disable interrupts (e.g., use thread polling instead) may provide better performance than the common configurations. Example performance increases may include, e.g., decreasing the stress of hardware interrupts, decreasing wasted CPU utilization that may be critical to CPU bound system. Moreover, in some implementations, the present disclosure may similarly work without any RDMA API hacking.

In some implementations, a polling logic of the polling operation may be integrated into a running framework for the command to poll from inside the running framework.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
receiving, by a computing device, a command, wherein the command includes one of a write command and a read command;
placing a completion request for a first portion of the command in a first queue when the completion request is a first type of completion request;
executing an interrupt operation for the completion request when the completion request is the first type of completion request;
placing the completion request for a second portion of the command in a second queue when the completion request is a second type of completion request; and
executing a polling operation for the completion request when the completion request is the second type of completion request.

2. The computer-implemented method of claim 1 wherein the first type of completion request is a completion of a receive request for the command.

3. The computer-implemented method of claim 1 wherein the second type of completion request is a completion of a read request for the command.

4. The computer-implemented method of claim 1 wherein the second type of completion request is a completion of a send request for the command.

5. The computer-implemented method of claim 1 wherein the first queue is a remote direct memory access completion queue for the interrupt operation.

6. The computer-implemented method of claim 5 wherein the second queue is a remote direct memory access completion queue for the polling operation.

7. The computer-implemented method of claim 6 wherein the first queue is a send queue, and wherein the second queue is a receive queue.

8. A computer program product residing on a computer readable storage medium having a plurality of instructions stored thereon which, when executed across one or more processors, causes at least a portion of the one or more processors to perform operations comprising:
receiving a command, wherein the command includes one of a write command and a read command;
placing a completion request for a first portion of the command in a first queue when the completion request is a first type of completion request;
executing an interrupt operation for the completion request when the completion request is the first type of completion request;
placing the completion request for a second portion of the command in a second queue when the completion request is a second type of completion request; and
executing a polling operation for the completion request when the completion request is the second type of completion request.

9. The computer program product of claim 8 wherein the first type of completion request is a completion of a receive request for the command.

10. The computer program product of claim 8 wherein the second type of completion request is a completion of a read request for the command.

11. The computer program product of claim 8 wherein the second type of completion request is a completion of a send request for the command.

12. The computer program product of claim 8 wherein the first queue is a remote direct memory access completion queue for the interrupt operation.

13. The computer program product of claim 12 wherein the second queue is a remote direct memory access completion queue for the polling operation.

14. The computer program product of claim 13 wherein the first queue is a send queue, and wherein the second queue is a receive queue.

15. A computing system including one or more processors and one or more memories configured to perform operations comprising:
receiving a command, wherein the command includes one of a write command and a read command;
placing a completion request for a first portion of the command in a first queue when the completion request is a first type of completion request;
executing an interrupt operation for the completion request when the completion request is the first type of completion request;
placing the completion request for a second portion of the command in a second queue when the completion request is a second type of completion request; and
executing a polling operation for the completion request when the completion request is the second type of completion request.

16. The computing system of claim 15 wherein the first type of completion request is a completion of a receive request for the command.

17. The computing system of claim 15 wherein the second type of completion request is a completion of a read request for the command.

18. The computing system of claim 15 wherein the second type of completion request is a completion of a send request for the command.

19. The computing system of claim 15 wherein the first queue is a remote direct memory access completion queue for the interrupt operation, and wherein the second queue is a remote direct memory access completion queue for the polling operation.

20. The computing system of claim 19 wherein the first queue is a send queue, and wherein the second queue is a receive queue.
